(19) United States
(12) Patent Application Publication
(10) Pub. No.: US 2004/0261476 A1
(43) Pub. Date: Dec. 30, 2004

(54) Big-Un vehicle security device

(76) Inventor: Victor George Dix, Benfleet (GB)

Correspondence Address: VICTOR G. DIX, 40 CHESTNUT GROVE, BENFLEET, SS7 5RX, GB

(21) Appl. No.: 10/606,254

(22) Filed: Jun. 26, 2003

(51) Int. Cl. G05G 5/00; F16H 57/00

(52) U.S. Cl. 70/203

(57) ABSTRACT

The Big-Un™ vehicle security device prevents the theft of vehicles and is particularly suitable for use with large vehicles such as commercial vehicles, emergency vehicles, heavy plant, military vehicles and utility vehicles. In use, the device prevents at least one pedal being operated comprising: a security device and a locking member which is releaseably connected to the securing device and which prevents the or each pedal being operated wherein said securing device comprises an elongated member sized such that it extends from the or each pedal through an aperture in the steering wheel and into the area normally occupied by a driver when seated within the vehicle in the conventional driving position. With all of the known immobilisation devices, one particular problem is that when being used lawfully by the owner of the vehicle they are disengaged when the driver is seated in the vehicle and thus, a thief can sit within the vehicle while trying to free the immobilisation device and is therefore not conspicuous to passers-by. The Big-Un™ vehicle security device overcomes this problem. A particularly preferred embodiment requires that the thief cannot sit in the driver's seat while trying to free the immobilisation device and is therefore more conspicuous to passers-by.

The present invention relates to a security device. More particularly the invention relates to a security device, which prevents the theft of vehicles. The security device of the present invention is particularly suitable for use with large vehicles such as commerical vehicles, emergency vehicles, heavy plant, military vehicles and utility vehicles.

### BACKGROUND TO THE INVENTION

The theft of vehicles is not uncommon. In an attempt to prevent such thefts, detection systems have been provided which detect the attempt being made to steal the vehicle. These systems, when activated, usually emit an audible alarm to alert passer-by to the attempted theft and/or immobilise the vehicle to prevent its removal.

Although such devices go some way to addressing the problem of reducing thefts they do have certain disadvantages and drawbacks. One such drawback is that the general public have become so accustomed to such audible alarms that it is increasingly unusual for a passer-by to take any action. A second drawback is that the systems usually only operate once the thief has actually gained access to the interior of the vehicle and therefore damage to the vehicle has usually already occurred. Thus, whilst the detectors may prevent the actual theft, they do not prevent any attempt being made to steal the vehicle. Finally, such systems are often expensive and time consuming to install.

Physical immobilisation means have also been suggested in an attempt to reduce the number of thefts. Such physical immobilisation means are usually visible from outside the vehicle and thus act as a deterrent to the thief. Known physical immobilisation means include those, which are attached to the steering wheel to restrict the ability of the driver to turn the wheel.

This is because they extend tangentially from the wheel and as the wheel is turned generally contact a part of the vehicle such as the windscreen, thereby preventing the wheel being turned further.

Such devices are, however, less suitable for use with large vehicles where there is usually more space in the driver's compartment and therefore contact with, for example the windscreen (windshield) is unlikely to occur.

Other immobilisation means are known which attempt to connect the handbrake to the gear stick. Whilst suitable devices have been suggested for use in small vehicles such as cars, the arrangement of the gear stick and handbrake does not lend itself to the use of devices of this type.

Other arrangements involving connecting the steering wheel to one pedal which again serves to restrict the rotation of the steering wheel and in addition may prevent the pedal from being depressed. However, devices of this type have the disadvantage in that thieves were able to remove them by distorting the rim of the steering wheel that usually has at least some flexibility and/or manipulating the shaft of the pedal.

With all of the known immobilisation devices, one particular problem is that when being used lawfully by the owner of the vehicle they are disengaged when the driver is seated in the vehicle and thus, a thief having gained entrance to the vehicle can sit within the vehicle while trying to free the immobilisation device and is therefore not conspicuous to passers-by.

### BRIEF SUMMARY OF THE INVENTION

There is now provided a security device which overcomes the aforementioned problems and provides a device which is simple to operate but which cannot readily be removed by a thief and which in a particularly preferred embodiment requires that the thief cannot sit in the driver's seat while trying to free the immobilisation device and is therefore more conspicuous to passers-by.

Thus, according to the current invention there is provided a vehicle security device which in use prevents at least one pedal being operated comprising: a security device and a locking member which is releaseably connected to the securing device and which prevent the or each pedal being operated wherein said securing device comprises an elongated member sized such that it extends from the or each pedal through an aperture in the steering wheel and into the area normally occupied by a driver when seated within the vehicle in the conventional driving position.

The elongate member preferably has at least one pair of diametrically situated apertures located proximal to the first end; and a locking member a part of which passes through said at least one pair of apertures to lock the elongate member to at least one foot pedal of the vehicle.

In a particularly preferred arrangement, the elongate member has two pairs of diametrically situated apertures and the locking member includes a containing element having conjoined limbs, each of which is received in a respective one of said pair of apertures. The containing element is preferably arranged such that in use one limb is positioned above and one limb below at least one foot pedal.

In an even more preferred arrangement, one limb of the locking member extends in use above and the other one limb extends in use below two foot pedals between which the elongate member is located. The foot pedals are usually the brake and the clutch pedals. However, particularly in an automatic vehicle the two foot pedals located may be the brake and the accelerator.

In the preferred arrangement in which two pedals are locked, the security device according to the present invention operates simultaneously to immobilise two of the foot pedals of the vehicle as they are restrained by the limbs of the locking member. By this means, the pedals cannot be moved upwardly or downwardly.

Further, since the elongate member extends through the steering wheel, the security device of the present invention not only immobilises the pedals, it also immobilises the steering wheel by preventing rotation of the steering wheel as, if the wheel is turned, a spoke of the steering wheel at the sides of the aperture will abut the elongate member and since movement of the elongate member is prevented due to the first end being secured to the pedals, movement of the steering wheel is restricted.

The elongate member is sized such that it extends into the area normally occupied by a driver when seated in the conventional driving position. By this means the potential thief is prevented from casually sitting within the vehicle whilst attempting to remove the security device. When the device of the present invention in its preferred embodiment is used, the thief must stand outside the vehicle and lean into the foot-well to remove the security device during which the thief will be very conspicuous.

In the preferred arrangement in which the containing member of the locking member includes two limbs, in order to remove the security device, the thief must cut through both the upper and lower limbs of the containing member to release the foot pedals.

Even if the elongate member is cut so that the second end can be removed such that the device no longer extends through the aperture in the steering wheel, the locking member will still contain the foot pedal or pedals, and as this is connected to the remaining portion of the elongate member i.e. the pedal end depression of the floor pedals is still restricted or in an embodiment in which the elongate member rests on the floor of the vehicle, depression of the foot pedals will be prevented.

A further advantage of the security device of this preferred embodiment of the present invention is that it is highly visible from outside the vehicle, and thereby acts as a deterrent to the opportunist thief.

In the preferred arrangement in which two pedals are locked, the security device according to the present invention operates to simultaneously immobilise two of the foot pedals of the vehicle as the limbs of the locking member restrain them. By this means, the pedals cannot be moved upwardly or downwardly.

### DETAILED DESCRIPTION OF THE INVENTION

Particularly preferred embodiments of the present invention will now be described, by way of example, in which:

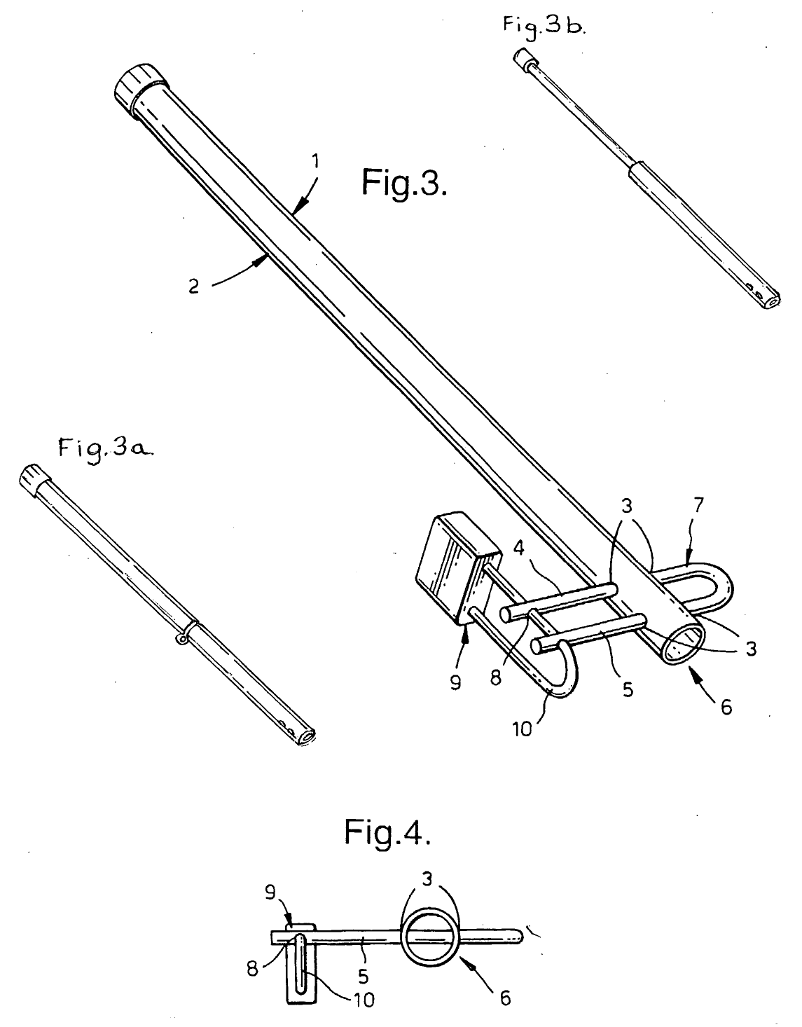

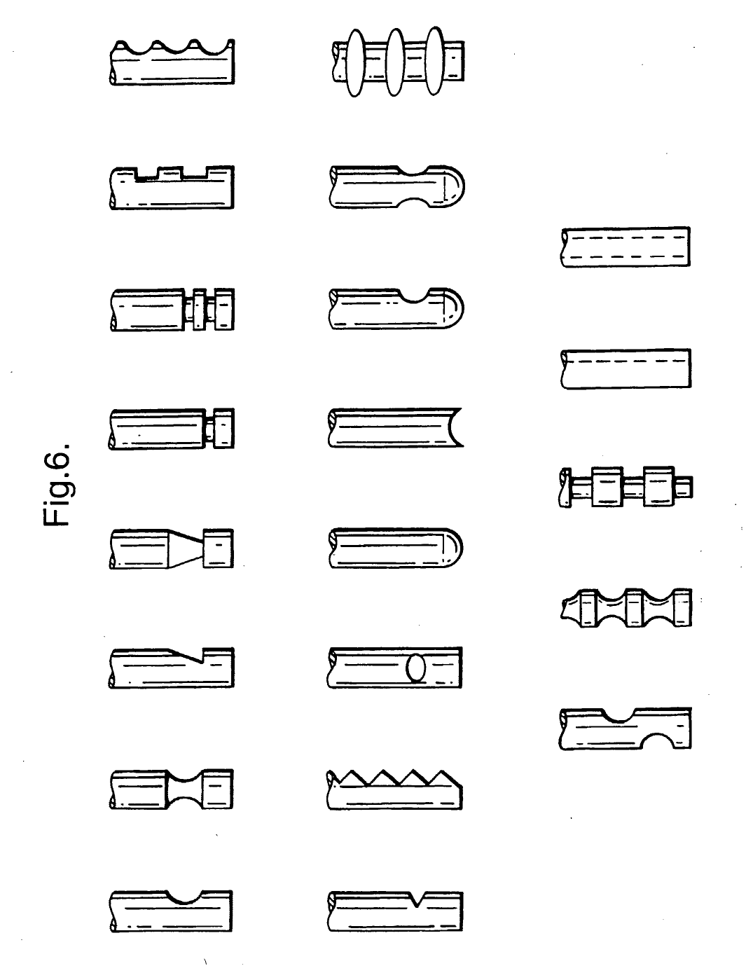

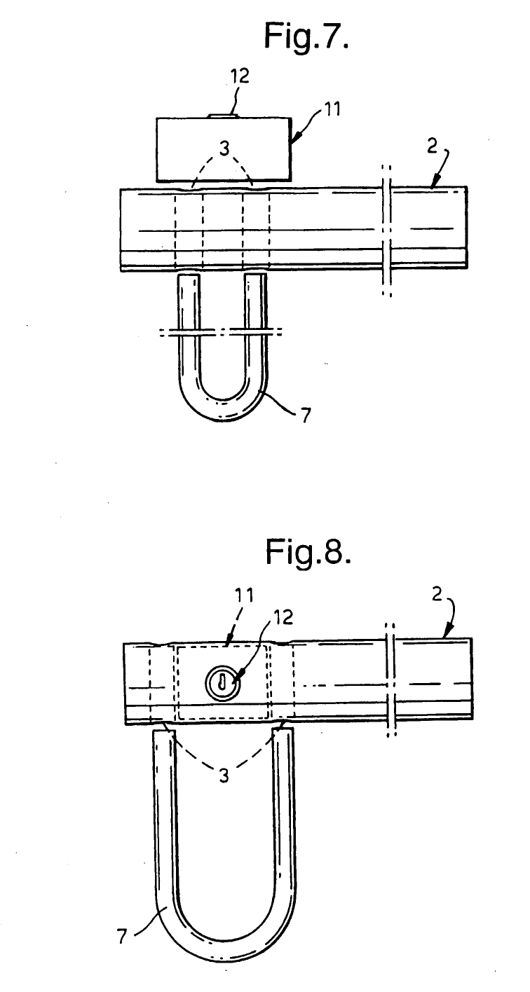

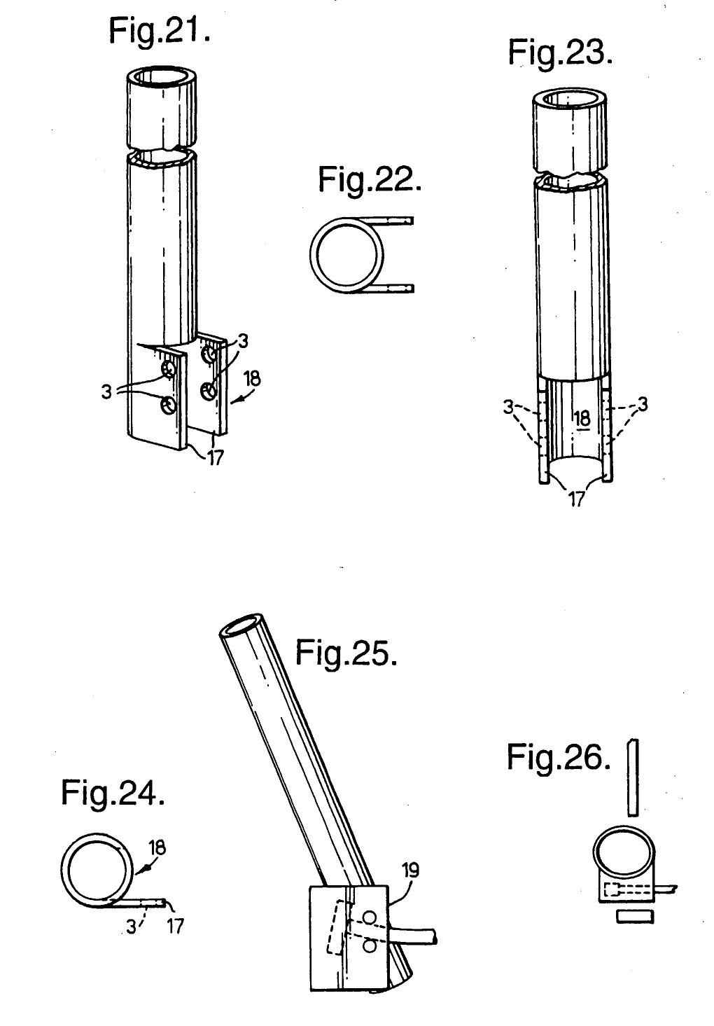

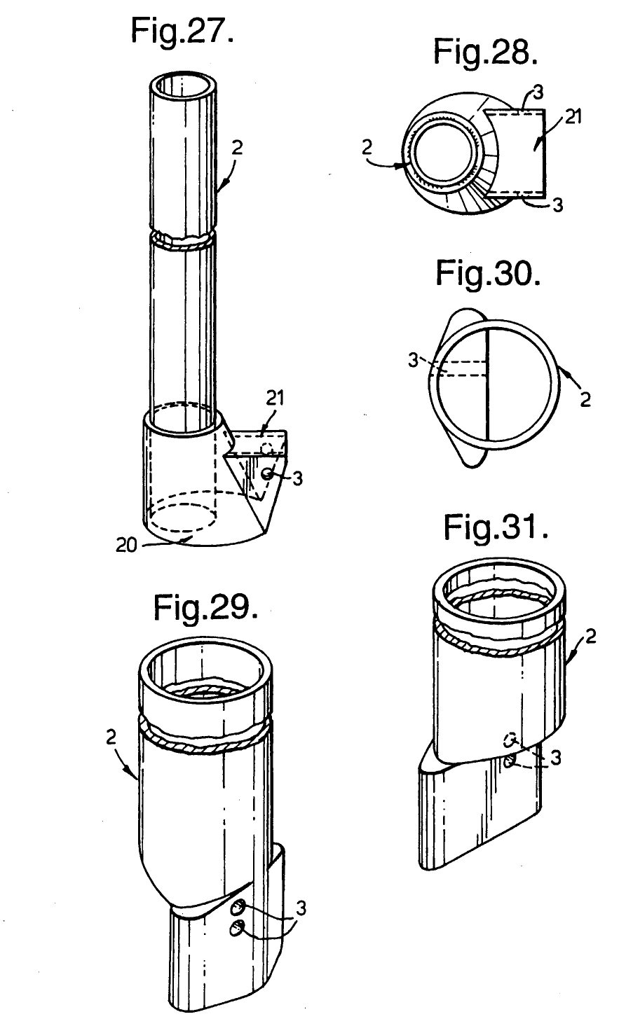

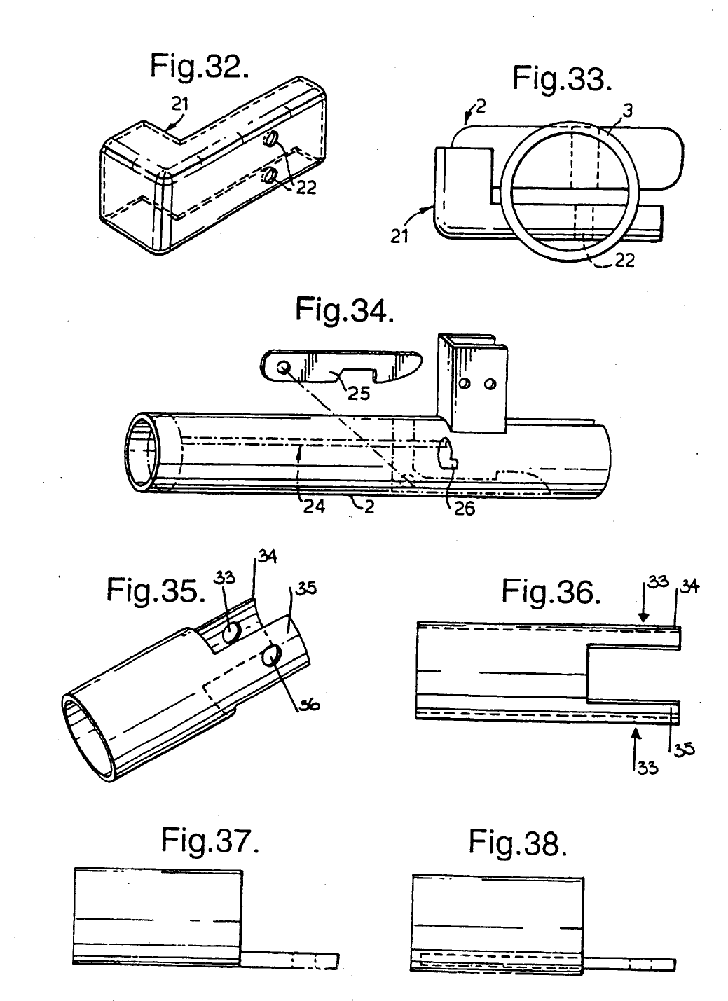

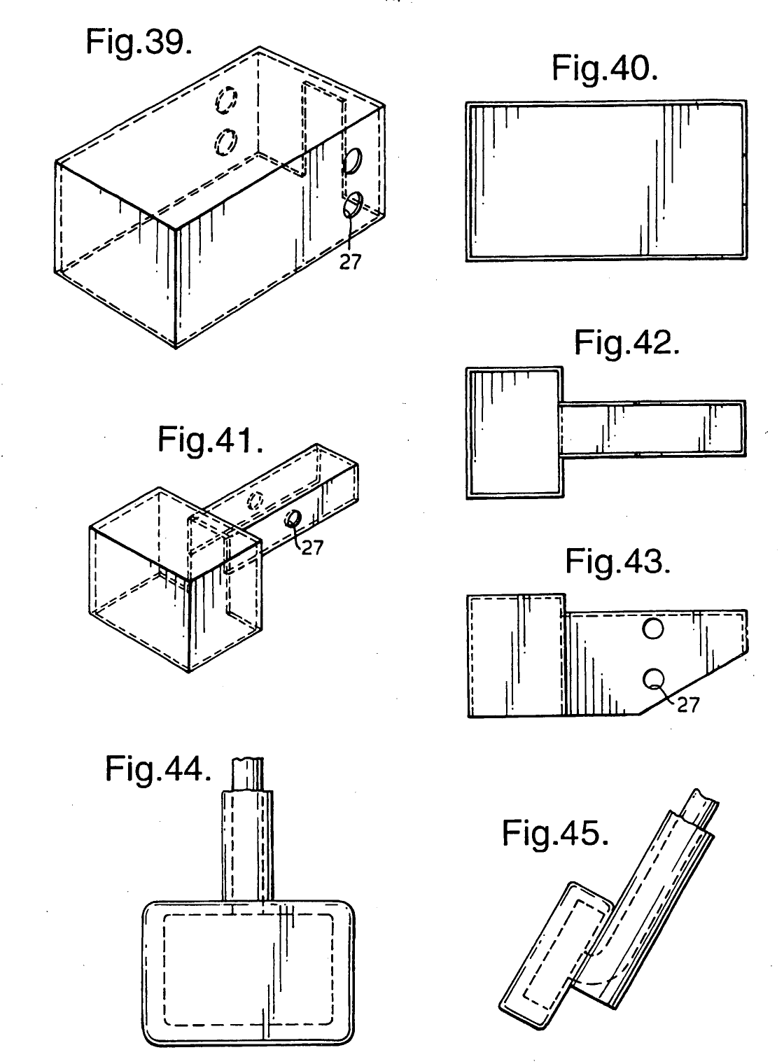

Is a schematic representation of a selection of x-sections of the elongate
member;
Is a schematic representation of a selection of profiles of the foot pedal end
of the elongate member;
Is a perspective view of one embodiment of the security device of the
present invention;
Is a perspective view of the elongate member formed of two discrete pieces;
Is a perspective view of the elongate member being collapsible;
Is a view from the foot pedal end of the device of FIG. 3;
Is a schematic representation of a selection of containing elements of the
locking member;
Is a schematic representation of a selection of configurations for the free
end or ends of the containing elements for being received into a lock;
Is a schematic diagram of a preferred arrangement of the present invention;
Is a schematic diagram of an alternative configuration for the preferred
embodiment of FIG. 7;
Is a schematic diagram of a further alternative configuration for the
preferred embodiment of FIG. 7;
Is a schematic diagram of a second further alternative configuration for the
preferred embodiment of FIG. 7;
Is a schematic diagram of a third further alternative configuration for the
preferred embodiment of FIG. 7;
Is a schematic diagram of a forth further alternative configuration for the
preferred embodiment of FIG. 7;
Is a schematic diagram of a fifth further alternative configuration for the
preferred embodiment of FIG. 7;
Is a schematic diagram of a sixth further alternative configuration for the
preferred embodiment of FIG. 7;
Is a schematic diagram of a seventh further alternative configuration for the
preferred embodiment of FIG. 7;
Is a schematic diagram of a eighth further alternative configuration for the
preferred embodiment of FIG. 7;
Is a schematic diagram of a ninth further alternative configuration for the
preferred embodiment of FIG. 7;
Is a schematic diagram of a tenth further alternative configuration for the
preferred embodiment of FIG. 7;
Is a schematic diagram of a eleventh further alternative configuration for the
preferred embodiment of FIG. 7;
Is a schematic diagram of alternate arrangements for the containing
element;
Is a side view of an alternative arrangement of the present invention;
Is a view from above of the arrangement of FIG. 21;
Is a front view of the arrangement of FIG. 21;
Is a view from above of an alternate arrangement of FIG. 21;
Is a perspective view of a still further arrangement;
Is a diagram of the view from above of the arrangement of FIG.
25;
Is a perspective, partly schematic view of a still further embodiment;
Is a view from above of the arrangement in FIG. 27;
Is a perspective view of a still further arrangement;
Is a view from above of the arrangement of FIG. 29;
Is a side view of part of the elongate member of FIG. 29;
Is a perspective view of a pedal cover for use with the elongate
member of FIG. 29;
Is a schematic view from above of the elongate member of FIG.
29 and the pedal cover of FIG. 32 in use;
Is a schematic view of a still further arrangement;
Is a perspective view of a pedal cover;
Is a view from above of the pedal cover in FIG. 35;
Is a view from above of an alternative pedal cover;
Is a view from above of a further alternative pedal cover;
Is a perspective, partially schematic, view of a still further
alternative pedal cover;
Is a view from above of the pedal cover of FIG. 39;
Is a perspective, partially schematic, view of a still further
alternative pedal cover;
Is a view from above of the pedal cover in FIG. 41;
Is a perspective, partially schematic, view of a still further
alternative pedal cover;
Is a perspective view of the pedal cover of FIG. 41 in use;
Is a perspective view of FIG. 44;
Is a perspective view of the arrangement of the present invention
using a pedal cover;
Is a perspective view of the arrangement of the present invention
using an alternative pedal cover;
Is a schematic diagram

Although the elongate member of the invention may be solid, it is preferably tubular.

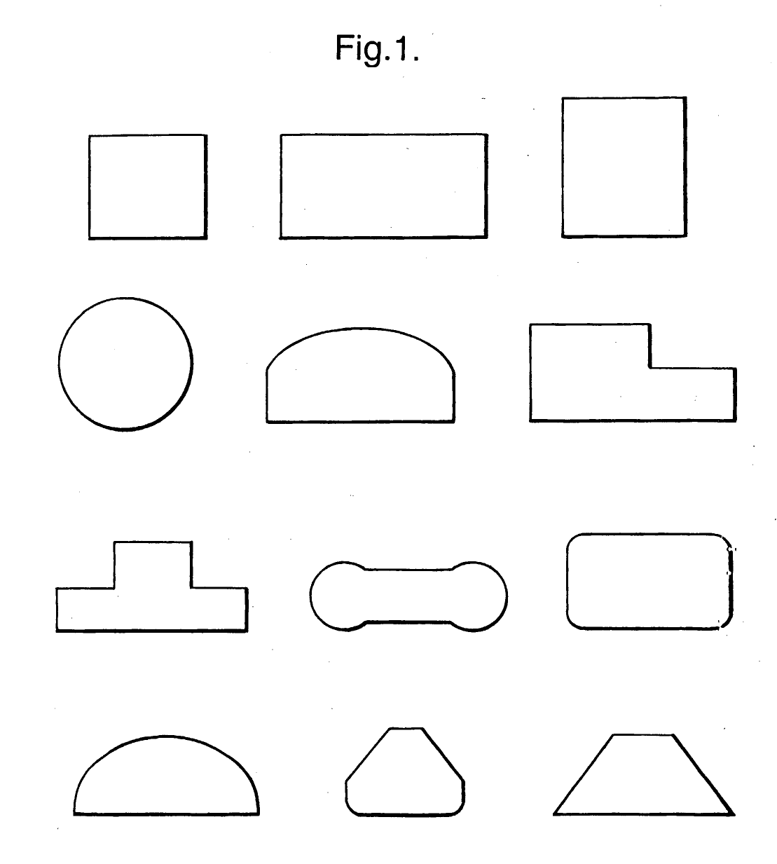

The elongate member may be of any cross-section and a selection of suitable cross-sections is shown in FIG. 1.

For ease of manufacture, the elongate member is preferably of circular cross section. A tubular elongate member has considered strength whilst being substantially lighter than the corresponding solid elongate member. The preferred tubular member is also difficult to cut since as the cut is started, the tubular nature of the member will tend to clamp any blade used to cut the member thereby impeding further cutting.

The elongate member may be made of any suitable material. Metals are particularly preferred. Particularly suitable metals include hardened steel which is inexpensive and strong and aluminum which is particularly light. Other metals and metallic alloys which may be suitable include vanadium, chrome, tungsten, titanium, stainless steel high carbon steels, molybdenum, duraluminium, gun-metal, magnesium, tool steels, nickel, zinc, brass, lead and bronze.

The elongate member may however be made of other materials such as plastics. Suitable plastics include nylon and PTFE. These plastic materials may be reinforced to increase their strength and increase the difficulty with which these are cut. Suitable reinforcement materials include carbon fibres, glass fibres and synthetic fibres.

A particular application of a harder material to strengthen a softer material of the elongate member is a hardened steel coil which is inserted to the elongate member for all or part of it's length. This will interfere with any attempt to saw or cut through the elongate member.

The elongate member may be formed from a single material or a combination of materials to give added strength or enhanced appearance. Thus the elongate member may be formed from steel and then coated with, for example, a plastics coating or it may be formed from a laminate material. Suitable laminates include steel/carbon laminates. The overall length of the elongate member is preferably at least 1 m, more preferably between 120 and 140 cm and most preferably 130 cm.

The elongate member may be collapsible for easy storage. The collapse may be achieved by simply forming the elongate member from discrete pieces, each piece having male end which is of a narrower diameter than the normal diameter of the elongate member and female end, such that in use the male end of one piece can interlock with the female end of another piece. In an alternative arrangement, the male end may be of the same diameter as the elongate member and the female end is larger to accept the male end. The male end of one piece of the member and the female end of another piece of the member may be joined by means of a spring which is under tension when the pieces are separated but is sufficiently flexible to allow them to be placed side by side for storage.

In an alternative arrangement, the collapse may be achieved by the elongate member being foldable and may include a hinge; a flexible flange or other means to flexible join parts of the elongate member together.

In a further alternative arrangements, the elongate member may be formed from a number of co-axial sections such that they can telescope together and then be extended when required.

The extendible elongate member may include means for locking the elongate member in its extended, i.e. non-collapsed configuration. Any suitable means may be included.

Howsoever formed, where the elongate member is extendable, it is preferred that, when contracted, the member has a length of between about 30 and 45 cm for ease of storage.

The elongate member may be of the same cross-section throughout its length. However, the cross-section may vary along the length of the member. As discussed in detail below, the foot pedal end of the elongate member may be shaped to receive a particular shaped locking member.

Advantageously, the elongate member has a bright colour to increase the visibility of the security device from outside the vehicle. This will act as a further deterrent to an opportunist thief.

Preferably the apertures of the elongate member, through which the containing member, or the limbs thereof pass, are provided at least about 10 cm from the foot pedal end of the elongate member. This ensures that when the security device is in position in the vehicle, the foot pedals cannot be depressed sufficiently to allow the vehicle to be driven.

The apertures in the elongate member must be sized to allow the containing member to pass through them. In a preferred arrangement, they are sized to allow for easy positioning of the limbs of the containing member. That is to say they have a size, which is greater than that of the external dimensions of the limbs.

The apertures may be of any convenient shape but are conventionally the same configuration as the cross-sectional shape of the limbs of the containing member. For ease of manufacture the limbs may have a circular cross-section and the apertures may similarly be circular.

The locking member of the present invention may be a single unit or it may be formed by more than one part. For example, it may be formed from a containing element and a separate lock. The containing element may be a U-shaped member.

In one arrangement the free ends of the limbs of the U-shaped member each include a hole through which the lock may be received. The locking member may be in the form of a shank which extends between the holes in the limbs of the U-shaped member and which is lockable in position so that it cannot be removed from the holes. In this way, there is a closed loop surrounding two foot pedals of the vehicle. In this case, the shank may be the hasp of a padlock. Alternatively, a separate shank may be passed through the holes and then locked in position by any suitable means.

In use, it is preferred that the locking member is positioned adjacent to the central housing of the vehicle making unauthorised access to this locking member inconvenient.

As illustrated in FIGS. 3 and 4, in its simplest arrangement, the security device of the present invention 1 comprises an elongate member; preferably steel tube 2 having a length of a round 1.2 m. Two pairs of diametrically located apertures 3 provided towards the foot pedal end 6 of the elongate member. The apertures 3 are arranged to receive the limbs 4 and 5 of a U-shaped steel member 7. The free end of the limbs 4,5 each include a hole 8 arranged to receive one limb of the hasp of a padlock 9. Thus in this arrangement the locking member is formed of two elements, the U-shape member and the padlock.

In use, the elongate member 2 is passed through an opening in the steering wheel of a vehicle, with one end extending into the space normally occupied by the driver seated in the driving position in the vehicle, the other end extending to the floor between two foot pedals, for example the brake and clutch pedals. In this position, the U-shaped member 7 is slid over one of the foot pedals, with one of the limbs 5 lying below the foot pedal, and the other limb 4 lying above the foot pedal. The U-shaped member 7 is slid through the holes 3 in the elongate member 2 so that the limbs extend above and below the adjacent foot pedal. The hasp 10 of the padlock 9 is then passed through the holes 8 in the ends of the limbs 4 and 5, and the padlock locked.

In this position, it is not possible for the steering wheel to be rotated, as the spokes connecting the center of the steering to the rim of the steering wheel will be impeded by the elongate member 2 extending through the opening of the steering wheel. It is also not possible to depress either of the foot pedals as these are restrained by the limbs 4 and 5 of the U-shaped member 7, which are themselves, restrained by the elongate member 2, the lower end of which abuts the floor.

For an authorised user to remove the security device, it is merely necessary to unlock the padlock 9, and slide the hasp 10 of the padlock 9 through the holes 8 in the limbs 4 and 5 of the U-shaped member 7, allowing the U-shaped member 7 to be removed from the holes 3 of the elongate member 2, such that the elongate member 2 may be removed from the opening of the steering wheel.

In contrast for a thief to remove the security device in order to steal the vehicle, it would be necessary to make at least 2 cuts. Unless both of the limbs 4 and 5 of the U-shaped member 7 are cut, it is not possible to remove the member 7 to allow the foot pedals to be depressed. Further, even with two cuts made to the U-shaped member, it may still not be possible to remove the elongate member 2 from the opening in the steering wheel, and therefore the steering wheel may still be immobilized. Even if the elongate member 2 is cut to release this from the opening of the steering wheel to release the steering wheel, the U-shaped member surrounding the foot pedals will still restrain depression of the foot pedals.

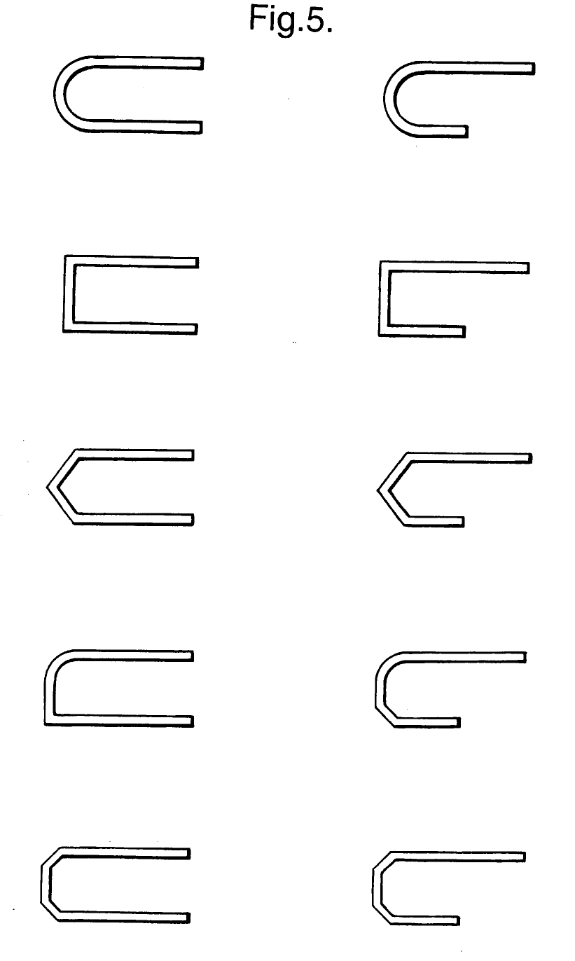

Whilst reference has been made to a U-shaped member, it will be understood that any arrangement may be used in which there are two limbs to pass through the apertures in the elongate member and to surround the or each pedal. A selection of arrangements is illustrated in FIG. 5. However, it will be understood that the illustrated arrangements are not exhaustive. Indeed, the member having the limbs need not even be substantially U-shaped but for ease of reference, all suitable configurations will be referred to as being U-shaped.

In a particularly preferred arrangement, the U-shaped member does not include holes at the ends of the limbs and a shackle is not used to lock the limbs in position. In this preferred arrangement, the limbs of the rod are received directly into the lock as illustrated in FIG. 7. As shown in FIG. 7 the lock is formed as a block 11 having a keyhole 12 to enable the lock to be released. Any suitable locking mechanism may be used within the lock.

In this arrangement, the free end of each limb of the rod can be considered as equivalent to the free end of a padlock, which on locking is received into the body of the lock. In order for the limbs of the U-shaped member to interact with the lock and be properly held in place, they may be shaped. A selection of suitable shapes is illustrated in FIG. 6. Again, the selection of configurations detailed in FIG. 6 should not be considered to be exhaustive.

In order to reduce the number of discrete parts of the security device, the lock may be an integral part of the elongate member as illustrated in FIG. 8. In the arrangement of FIG. 8, the lock is located in the elongate member with the keyhole positioned in a plane parallel to the plane of the U-shaped member. It will be understood that in this arrangement, the U-shaped will generally enclose only one pedal, however, the member may be sized so that two pedals can be locked between the elongate member and the bend of the U-shaped member.

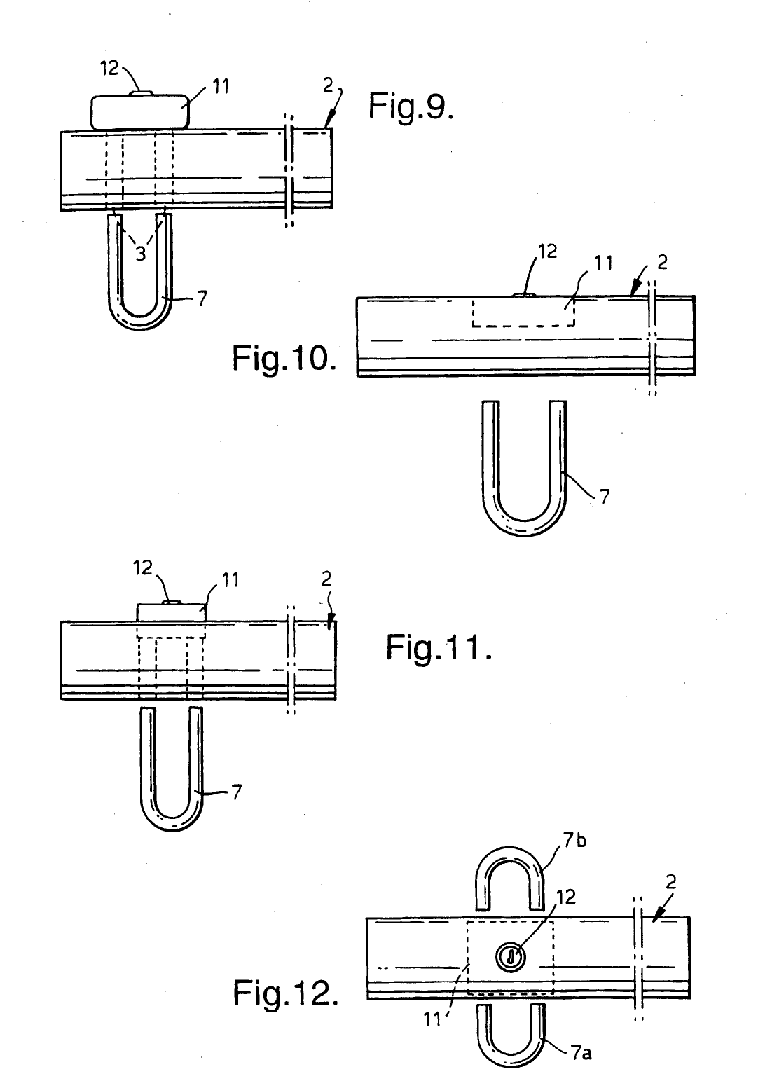

In the arrangement of FIG. 9, the lock, rather than being located within the elongate member may be attached to one surface thereof. The lock may be fully embedded in one side of the elongate member 2 as illustrated in FIG. 10 or may be partially embedded as illustrated in FIG. 11.

As illustrated in FIG. 12, where the lock is embedded in the elongate member, two U-shaped members, 7a and 7b, may be used such that the security device of the present invention can secure two pedals located on opposing sides of the elongate member.

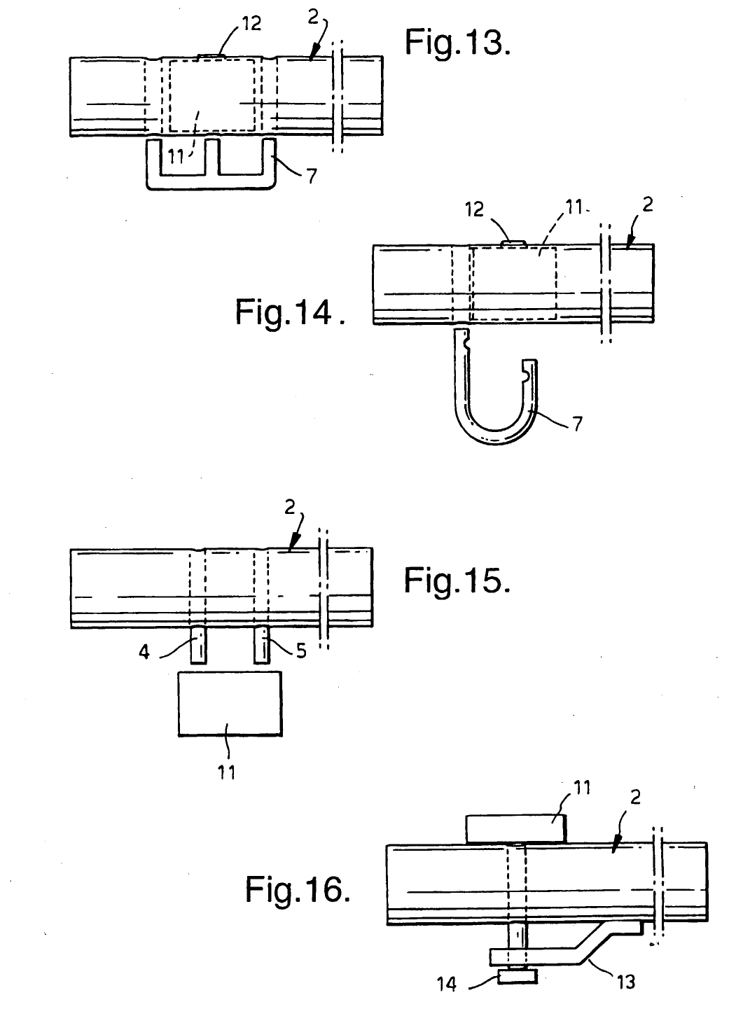

As has been discussed above, the containing member may be of any shape and in the arrangement in FIG. 13 it is E-shaped in which the central limb passes through the aperture into the lock and the other two limbs pass through apertures into the elongate member 5 to prevent movement of the U-shaped member.

A further arrangement is illustrated in FIG. 14. Here one limb of the U-shaped member in use passes through an aperture into the lock and the longer limb passes through an aperture alongside the body of the lock and is locked at a second point on the side of the lock within the body of the elongate element making it even more difficult to remove.

Although the U-shaped member is illustrated as being a separate element, in a further arrangement, the U-shaped member may be secured in the side channel but moveable therein such that the U-shaped member behaves as the sank of a conventional padlock. That is to say in use, the elongate member is placed in position and the U-shape member is then turned to surround the shaft of the pedal before being snapped into the lock 11.

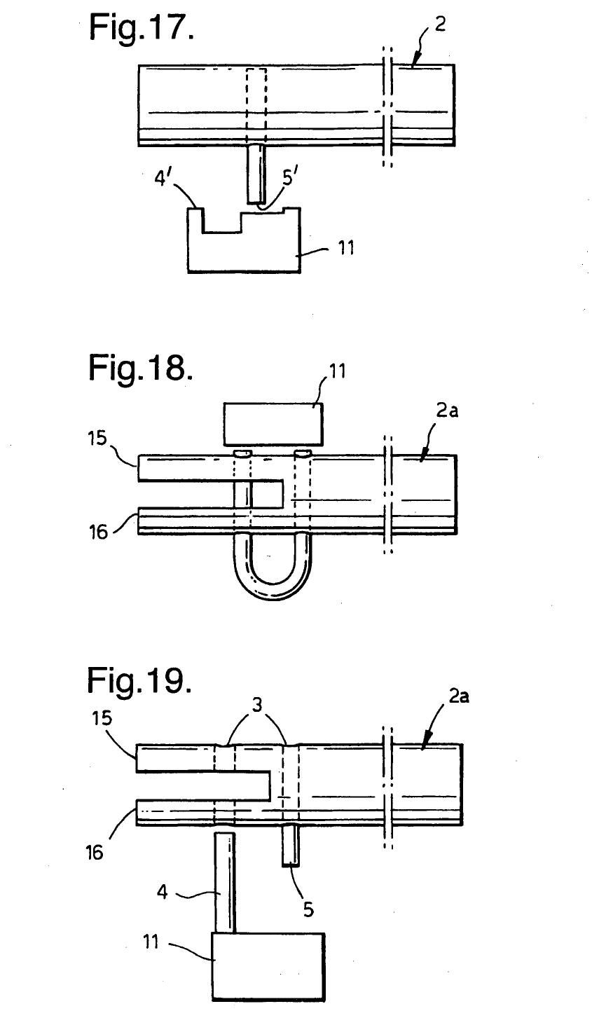

In an alternative arrangement of the present invention, the two limbs 4 and 5 of the containing element may be integral with the elongate member 2 and the lock 11 may be separate so that in use, the elongate member is placed in position and the lock is then pushed onto the limbs. Where the containing element is integral with the elongate member has only 1 limb 5′ as in FIG. 17, the lock member 11 may have an external configuration which is shaped to form the second arm 4′ of the loop which encloses the pedal.

Alternatively, an arm 13 extending from the wall of the elongate member 2 and a single shaft 14 extending through the elongate member 2 into the lock 11 may enclose the pedal. This arrangement is illustrated in FIG. 16.

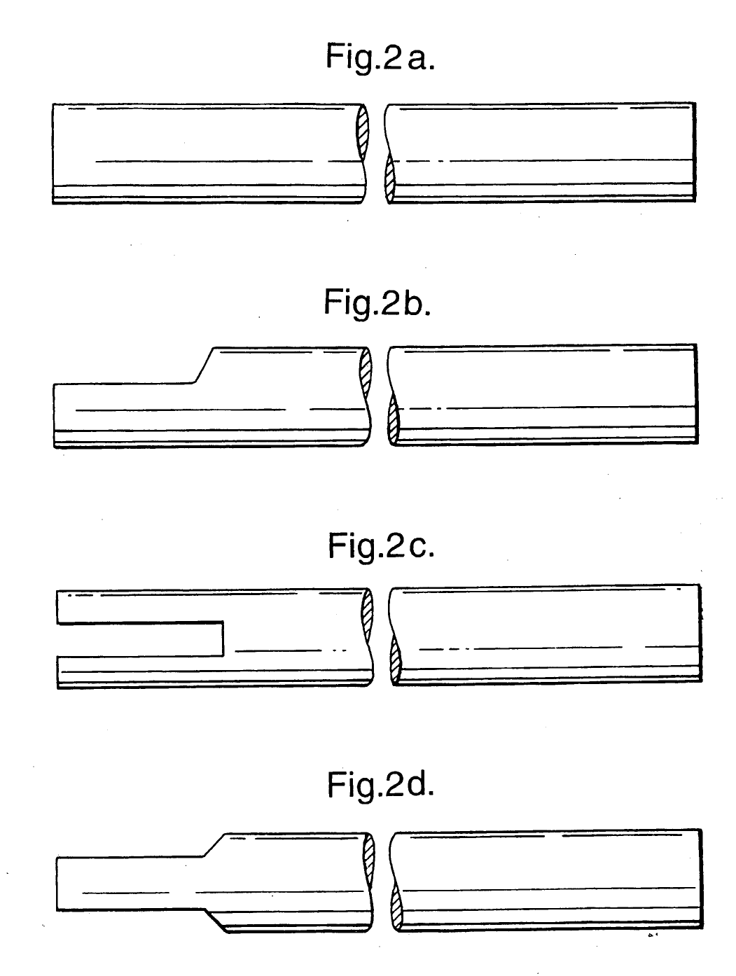

As illustrated in FIG. 2 the elongate member may be of a range of configurations. As shown in FIG. 2c, the foot pedal end of the elongate member may be forked. One use of the arrangement of this elongate member is illustrated in FIG. 18. In this arrangement, the forked legs 15 and 16 of the elongate member 2a are placed around the arm of one foot pedal and then locked in place using the containing element, preferably the U-shaped member 7, and the lock 11.

In a preferred arrangement, the U-shaped member will surround the shaft of a second foot pedal before passing through the elongate member.

As with the other arrangement various modifications of the arrangement of FIG. 18 may be used. For example, as illustrated in FIG. 19, the elongate member may have as an integral element thereof the arm 5 whilst the lock 11 carries the arm 4 so that in combination the arm 4 and the lock 11 with arm 5 forms the containing element.

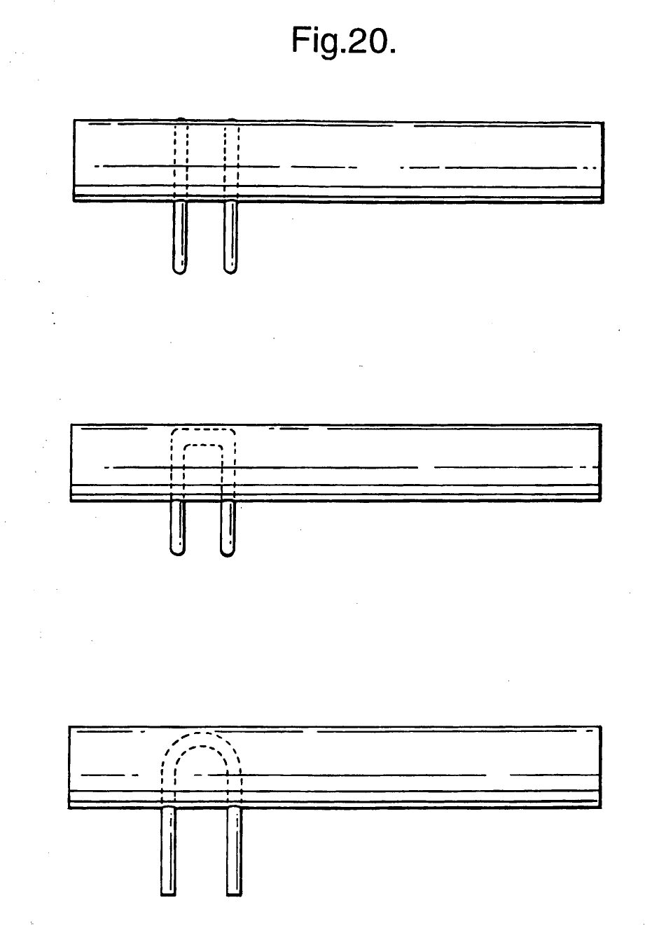

FIG. 20 illustrates a selection of the arrangement in which the containing elements may be located within the elongate member such that the limbs of the containing element extend through the apertures on one side of the elongate member to interact with the lock member. It will be noted that in one arrangement the containing element comprises two discrete limbs which are connected only be the wall of the elongate member.

In an alternative embodiment, one or more pedals maybe enclosed as a means of locking the elongate member 2 to the pedal. A particular advantage of this arrangement is that access to the pedal is minimised, as is access to the limbs of the containing element thereby making it more difficult for the limbs to be cut.

As shown in FIGS. 21 to 23 the foot pedal end of the elongate member may be arcuate and have flanges 17 extending from each side of the arc. In use the elongate member is placed in position whereby one of the pedals is located within the cave 18 formed by the flanges and the arcuate member. The containing element, particularly a U-shaped member, may then be passed through the apertures 3 in the walls of the flanges to lock the pedal in position.

In an alternative arrangement, a pedal cover may be used to enclose the pedal. In the arrangement of FIGS. 25 and 26, a pedal cover 19 is connected to the side of the elongate member 2. Two pedal covers may be located each on opposing sides of the elongate member such that in use two pedals are enclosed. Alternatively, the arrangement of FIG. 21 may be combined with that in FIG. 25 such that one pedal is enclosed in the cave 18 and the other by the pedal cover 19.

The pedal cover 19 may be attached to the elongate member by any suitable means. Suitable means include nuts and bolts, rivet and welds.

A further alternative arrangement for enclosing a pedal is illustrated in FIGS. 27 and 28. Here a shroud 20 is attached to the foot pedal end of the elongate member by any suitable means, preferably welds. The shroud which serves to increase the cross-sectional area of the elongate member in the area of the foot pedal has an integral pedal cover 21 which in use surrounds the pedal and is then locked in place by any conventional means including the U-shaped member and lock discussed in detail above.

In a still further embodiment, the foot pedal end of the elongate member may be pinched as illustrated in detail in FIGS. 29, 30 and 31. Flattening the tube may form the pinched end or may be a separate element connected to the main elongate member. The elongate member 2 of this configuration may be used in any of the arrangement discussed above but is particularly useful for use with an L-shaped pedal cover 21 which in use clamps around the pedal and in combination with a containing element preferably a U-shaped member, and lock or any of the alternative arrangements detailed above is connected to the elongate member 2 via the apertures of the pedal cover 22 and the apertures 3 in the elongate member.

Where the elongate member is open at the foot end to accept a pedal, as in the arrangement of FIG. 34, the elongate member may include an internal lock 24, which includes locking blades 25 and a cam lock peg 26. When the elongate member is placed around the pedal, the lock is activated so that the elongate member cannot be removed from the pedal until the lock is deactivated. Any suitable locking mechanism may be used.

As discussed, a pedal cover may be used to secure the pedal to the elongate member. In one arrangement, the pedal cover may be substantially box-like and a selection of suitable arrangements is illustrated in FIGS. 39 to 43 and FIGS. 44 and 45. Each arrangement includes apertures 27 to allow a locking means to be used to secure the pedal cover to the pedal and/or the elongate member. The pedal cover may be sized to cover one or two pedals.

In an alternative arrangement the pedal cover may be cylindrical as illustrated in FIGS. 35 38. Again any suitable configuration may be used. The cylindrical pedal cover may include limbs 34 and 35 for ease of operation and these limbs may include apertures 33 and 36 to allow a locking means to be used to secure the pedal cover to the pedal and/or to the elongate member. In an alternative arrangement illustrated in FIGS. 37 and 38 only one limb may be used. This may be formed as an integral element of the pedal cover as in FIG. 37 or as a separate part and then secured to the pedal cover as in FIG. 28.

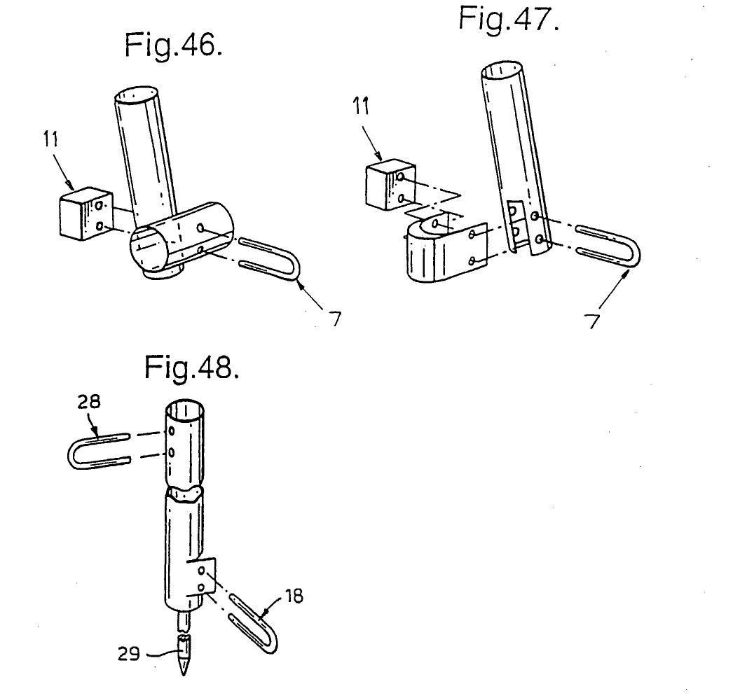

The use of pedal covers in combination with the elongate member is illustrated in FIGS. 46 and 47. As illustrated, the containing element, preferably a U-shaped member 7 is passed through apertures in the pedal cover plate and the elongate member before being connected into the lock 11.

The security device of the present invention may be fitted with a steering wheel clamp, lock or clamp and lock for additional security. Any suitable clamp and/or lock may be used. As illustrated in FIG. 48 the steering wheel lock 28 may be of the same configuration as any of the locking means used at the pedal end of the elongate member as discussed above. Thus, the locking means may include a U-shaped member and lock.

To further secure the elongate member and prevent movement of the security device, the elongate member may have a floor pin 29 extending from the base of the foot pedal end of the elongate member. The floor pin 29 may prevent movement by means of friction between the tip of the pin and the floor covering or there may be a hole, or a socket located in the floor of the vehicle to accept the pin.

Where the pin is used, any cave 18 for accepting a pedal will generally have a floor in that the bottom of the elongate member 2 will generally be solid to provide support for the pin. Alternatively, the pin may be attached to a wall of a tubular elongate member.

The containing element, U-shaped member and the shackles, pins locks, pedal covers, floor pins and shrouds and other elements, may be formed from any suitable material in particular those detailed above in connection with the manufacture of the elongate member may be used. However, they are preferably formed of high strength material, such as steel, and may be strengthened to help prevent unauthorized removal.

Each part of the security device may be painted or coated as required. Fluorescent coatings are particularly advantageous from a deterrent point of view. The items may be coated with abrasive materials to make it more difficult to get purchase on the surface for sawing.

The shackles, rods may be of any cross-sectional configuration. The cross-sectional configuration may vary along the length of the item. The rods, shackles etc may be solid or hollow. Hollow rods can be reinforced with cables, such as steel cables. In one arrangement a flexible locking means such as a steel rope or cable may be used.

The cover plates described above may be adjustable, such that once they are located around one or more pedal they can be adjusted to fit the pedal(s) closely. The locks used in the present invention may be of any suitable configuration. Whilst many of the figures illustrate the lock 11 as being rectangular, it will be understood that any shape may be used. The lock will generally be sized such that it is a deterrent but may be readily operated by the legitimate driver of the vehicle.

What I claim as my invention is:

1. A vehicle security device which in use prevents at least one pedal being operated comprising: a securing device and a locking member which is releaseably connected to the securing device and which prevents the or each pedal being operated wherein said securing devise comprises an elongate member sized such that it extends from the or each pedal through an aperture in the steering wheel and into the area normally occupied by the driver when seated within the vehicle in the conventional driving position.

2. The security device of claim 1, in which the elongate member in use has a first end, which is located in the foot pedal area of the vehicle, and a second end, which is passed through an aperture in the steering wheel.

3. The security device of claim 2, wherein the elongate member has at least one pair of diametrically situated apertures located proximal to the first end and the locking member is configured such that a part of it passes through said at least one pair of apertures to lock the elongate member to at least one foot pedal of the vehicle.

4. The security device of claim 3, wherein the elongate member has two pairs of diametrically situated apertures and the locking member comprises a lock and includes a containing element having two co-joined limbs, each of which is received in a respective one of said pair of apertures.

5. The security device according to claim 4, wherein the containing element is arranged such that in use one limb is positioned above and one limb below at least one foot pedal.

6. The security device according to claim 4 or 5, wherein the containing element is a U-shaped member.

7. The security device according to claim 4 or 6, wherein the free ends of limbs of the U-shaped member each include a hole through which the lock may be received.

8. The security device according to claim 4 or 7, wherein the free ends of limbs of the U-shaped member are each shaped to interact with the lock.

9. The security device according to any one of claims 4 or 8, wherein one of the containing element and the lock is integral with the elongate member.

10. The security device according to claim 4 or 8, wherein the lock is integral with the elongate member.

11. The security device according to any preceding claim, wherein the elongate member is formed from at least two discrete pieces.

12. The security device according to any preceding claim, wherein the elongate member is collapsible.

13. The security device according to any preceding claim, wherein the elongate member is formed from a number of co-axial sections such that they can telescope together.

14. The security device according to claim 11, wherein the collapsing of the elongate member is achieved by the elongate member being foldable.

15. The security device according to claim 12, wherein the folding of the elongate member is facilitated by a hinge or flexible flange or by a flexible means attached to the parts of the elongate members.

16. The security device according to any preceding claim, wherein the elongate member has an overall length of at least 1 meter.

17. The security device according to any preceding claim, wherein the elongate member has an overall length of between 120 centimetres and 140 centimetres.

18. The security device according to any preceding claim, wherein the elongate member has an overall length of between 30 centimetres and 45 centimetres in collapsed/contracted state.

19. The security device according to any one of claims 2 to 18, wherein the elongate member is configured to surround a portion of the pedal.

20. The security device according to any one of claims 2 to 19, wherein the elongate member is connected to a pedal cover, which surrounds a portion of the pedal.

21. A vehicle security device substantially as hereinbefore described, with reference to, and as illustrated in, the accompanying drawings.
